(19) United States
(12) Patent Application Publication
(10) Pub. No.: US 2023/0257579 A1
(43) Pub. Date: Aug. 17, 2023

(54) Fibre reinforced polyamide moulding compound

(71) Applicant: EMS CHEMIE AG, Domat/Ems (CH)

(72) Inventors: Etienne AEPLI, Domat/Ems (CH); Philipp HARDER, Chur (CH); Botho Hoffmann, Domat/Ems (CH)

(21) Appl. No.: 18/167,197

(22) Filed: Feb. 10, 2023

(30) Foreign Application Priority Data
Feb. 11, 2022 (CH) CH000127/2022

(51) Int. Cl. C08L 77/10; C08K 7/14; C08K 3/38; B29C 45/00

(52) U.S. Cl. CPC C08L 77/10; B29C 45/0001; C08K 3/38; C08K 7/14; B29K 2277/10

(57) ABSTRACT

The present invention relates to a polyamide moulding compound consisting of
A 33-79.4 wt% of a polymer mixture consisting of
   A1 55 to 85 wt% of at least one semi-crystalline, aliphatic polyamide selected from the group PA 6, PA 46, PA 56, PA 66, PA 66/6, PA 610, PA 612, PA 6/12, PA 1010, PA 11, PA 12, PA 1012, PA 1212 and mixtures thereof;
   A2 15 to 45 wt% of at least one semi-aromatic polyamide selected from the group PA 6l, PA 5l/5T, PA 6l/6T, PA 10l/10T, PA 10T/6T, PA 6T/BACT/66/BAC6, PA MXD6, PA MXD6/MXDl and mixtures thereof;
   wherein the sum of A1 and A2 is 100 wt% of A;
B 20 to 60 wt% of a reinforcing fibre;
C 0.6 to 2.0 wt% metal borate, wherein the molar ratio of metal to boron is in the range from 0.5 to 4;
D 0 to 5.0 wt% additives, different from A, B and C;
wherein the sum of the components A to D is 100 wt% and wherein the moulding compound comprises neither copper halides nor metal phosphinates.

The invention relates to fibre reinforced polyamide moulding compounds which, in addition to a selected polymer mixture, containing two different polyamide reinforcing fibres and metal borates. The present invention further relates to the use of such moulding compounds for producing moulded bodies and to the moulded bodies themselves.

Polyamides are currently widely used as structural elements for internal and external uses, which is substantially due to their outstanding mechanical properties. An improvement in the mechanical properties, such as strength and rigidity can be achieved, in particular, through the addition of fibrous reinforcing materials, e.g., carbon fibres or glass fibres.

EP 2 060 607 A1 relates to polyamide moulding compounds reinforced with a flat long glass fibre, which have advantages over moulding compounds made from rounded glass fibres, in terms of tear strength perpendicular to the processing direction, notched impact strength and flow length. WO 2014 160 564 A1 describes polyamide compositions that show improved thermal ageing behaviour through combination of copper and zinc compounds. In the examples according to the invention the zinc compounds, zinc oxide and zinc borate, are used in combination with the heat stabiliser, copper iodide.

Zinc compounds are often used as a synergist for flame retardants, as described for example in US 2010 113 655 A1. Here, flame retardants, fibre reinforced polyamide compositions based on semi-aromatic polyamides and metal phosphinates as flame retardants, which contain the mineral boehmite and/or zinc borate as flame retardant synergist are disclosed.

However, it has been shown that the fibre reinforced plastics previously known in the prior art, including polyamide moulding compounds which contain long fibres, do not yet provide satisfactory results in all respects. Thus, it is desirable to provide fibre reinforced polyamide moulding compounds and moulded parts produced therefrom, which have low warping, high rigidity and strength and an excellent surface quality with a simultaneous high filler content of reinforcing fibres. In particular, there is a great need for moulded bodies made from fibre reinforced polyamide moulding compounds which have superior properties to the prior art in terms of notched impact strength, heat distortion temperature (HDT) and resistance to moulds or bacteria. In addition, the properties in the dry and packaged state should differ from one another only slightly.

The problem addressed by the present invention is therefore that of specifying polyamide moulding compounds which can be processed into moulded bodies, wherein the moulded bodies, if possible simultaneously, have excellent properties in terms of warping, impact strength and notched impact strength, tensile strength at break and elongation at break, as well as surface quality, heat distortion temperature and resistance to moulds and/or bacteria. In particular, the polyamide moulding compounds should have a classification according to ISO 846:2020 (Plastic - Evaluations of the action of microorganisms) for the resistance to mould of “Zero” (0), “ONE A″(1a) or “One” (1) and for resistance to bacteria of “Zero” (0) or “One” (1).

This problem is solved with respect to the moulding compound through the features of claim 1, with respect to the moulded body through the features of claim 12, and with respect to the use through the features of claim 14. The dependent claims disclose advantageous developments.

According to the invention, this problem is solved on the one hand by a fibre reinforced polyamide moulding compound according to claim 1, wherein the polyamide moulding compound consists of the following components:
A 33-79.4 wt% of a polymer mixture consisting of
   A1 55 to 85 wt% of at least one semi-crystalline, aliphatic polyamide selected from the group PA 6, PA 46, PA 56, PA 66, PA 66/6, PA 610, PA 612, PA 6/12, PA 1010, PA 11, PA 12, PA 1012, PA 1212 and mixtures thereof;
   A2 15 to 45 wt% of at least one semi-aromatic polyamide selected from the group PA 6l, PA 5l/5T, PA 6l/6T, PA 6T/6l, PA 10l/10T, PA 10T/6T, PA 6T/BACT/66/BAC6, PA MXD6, PA MXD6/MXDI and mixtures thereof; wherein the sum of A1 and A2 is 100 wt% of A;
B 20 to 60 wt% of reinforcing fibres;
C 0.6 to 2.0 wt% metal borate, wherein the molar ratio of metal to boron is in the range from 0.5 to 4;
D 0 to 5.0 wt% additives, different from A, B and C;
wherein the sum of the components A to D is 100 wt% and wherein the moulding compound comprises neither copper halides nor metal phosphinates.

For the purposes of the present invention, the term “polyamide” (abbreviation PA) is understood to be a generic term which includes homopolyamides and copolyamides independent of their molar mass or viscosity. Therefore, the generic term polyamide includes both low molecular weight polyamide precondensates as well as post-condensed high molecular weight homopolyamides and copolyamides. The selected spellings and abbreviations for polyamides and their monomers correspond to those specified in ISO standard 16396-1 (2015 (D)). The abbreviations used therein are used synonymously with the IUPAC names of the monomers, in particular the following abbreviations for monomers occur: T or TPA for terephthalic acid, l or IPA for isophthalic acid, BAC for 1,3-bis(aminomethyl)cyclohexane (CAS Number 2579-20-6), MXDA for m-xylylenediamine (CAS Number 1477-55-0), In the following, HMDA is used as an abbreviation for 1,6-hexanediamine, also known as hexamethylenediamine.

Compared to the semi-crystalline polyamides, amorphous polyamides have no or only a very low, hardly detectable heat of fusion. The amorphous polyamides preferably show, in dynamic differential calorimetry (DSC) according to ISO11357 (2013), at a heating rate of 20 K/min, a heat of fusion of less than 5 J/g, particularly preferably a maximum of 3 J/g, very particularly preferably 0 to 1 J/g. Amorphous polyamides do not have a melting point due to their amorphous nature. In addition to a glass transition, semi-crystalline polyamides have a pronounced melting point and preferably show, in dynamic differential calorimetry (DSC) according to ISO11357 (2013) at a heating rate of 20 K/min, a heat of fusion of at least 15 J/g, particularly preferably at least 20 J/g, very particularly preferably in the range from 25 to 80 J/g.

With regard to the polyamides used according to the invention, the monomers of the dicarboxylic acid and of the diamine components, as well as any aminocarboxylic acids or monofunctional regulators used, form, by condensation, repeating units or end groups in the form of amides that are derived from the respective monomers. As a rule, these make up at least 95 mol%, in particular at least 99 mol% of all repeating units and end groups present in the polyamide. In addition, the polyamide can also have small amounts of other repeating units, which can result from degradation reactions or side reactions of the monomers, for example of the diamines.

The proposed fibre reinforced polyamide moulding compound according to the invention is characterised, according to independent claim 1, in that it is free from copper halides and metal phosphinates, i.e., it comprises neither copper halides nor metal phosphinates, and in that it has a polymer mixture A forming a polyamide matrix, which has been formed from specific starting materials A1 and A2.

The polyamide moulding compound according to the invention preferably contains component A in the range from 40.4 to 74.4 wt% and particularly preferably in the range from 46.6 to 69.25 wt%, in each case with respect to the sum of the components A to D.

The polymer mixture A comprises 55 to 85 wt% of at least one aliphatic, semi-crystalline polyamide A1, that is selected from the group PA 6, PA 46, PA 56, PA 66, PA 66/6, PA 610, PA 612, PA 6/12, PA 1010, PA 11, PA 12, PA 1012, PA 1212 and/or mixtures thereof. The polyamide A1 is preferably selected from the group PA 6, PA 56, PA 66, PA 66/6, PA 610 and mixtures thereof. A preferred mixture consists, for example, of PA 66 and PA 6 or of PA 610 and PA 6. In addition, the polymer mixture contains, as second component, 15 to 45 wt% of at least one semi-aromatic, amorphous or semi-crystalline polyamide A2, that is selected from the group PA 6l, PA 5l/5T, PA 6l/6T, PA 6T/6l, PA 10l/10T, PA 10T/6T, PA 6T/BACT/66/BAC6, PA MXD6, PA MXD6/MXDI and mixtures thereof. Preferred polyamides A2 are PA 6l/6T and PA 6T/BACT/66/BAC6.

The proportion of component A1 is preferably in the range from 60 to 85 wt%, preferably in the range from 65 to 80 wt%, and the proportion of component A2 is preferably in the range from 15 to 40 wt%, preferably in the range from 20 to 35 wt%, in each case with respect to the sum of components A to D.

In the proposed fibre reinforced polyamide moulding compound it is now essential that the polyamide matrix, which consists of 33 to 79.4 wt% of the above-described polymer mixture A, contains 20 to 60 wt% of a reinforcing fibre B, which is a cut fibre (short fibre) or a continuous fibre (long fibre, roving), preferably a continuous fibre (long fibre or roving).

The reinforcing fibre B is preferably a glass fibre, a basalt fibre or a carbon fibre or a mixture of these fibres, particularly preferably a glass fibre.

Particularly preferably the reinforcing fibre B is a continuous glass fibre (long glass fibre, roving).

Suitable continuous glass fibres have a diameter of 10 to 20 µm, preferably 11 to 18 µm, particularly preferably 12 to 17 µm, and very particularly preferably 11 to 13 µm. The continuous glass fibres can consist of all types of glass, such as D-glass, E-glass, ECR-glass, L-glass, S-glass, R-glass, or any mixtures thereof. The glass fibres are preferably made of E-glass, ECR-glass or S-glass or from mixtures of these fibres.

Suitable glass fibres have a cross-sectional area that can be either circular (or synonymously round) or non-circular (or synonymously flat), wherein in the latter case the dimensional ratio of the major cross-sectional axis to the minor cross-sectional axis is at least 2, and is preferably in the range from 2 to 6.

According to a preferred embodiment of the present invention, component B is present in the polyamide moulding compound at 25 to 55 wt% and particularly preferably at 30 to 50 wt%, wherein these quantities relate to the sum of components A to D.

Particularly preferably according to the invention, E-glass, ECR-glass and/or S-glass fibres are used. However, other glass fibre types can be used, such as D-glass, L-glass, R-glass fibres or any mixtures thereof or mixtures with E-glass, ECR-glass and/or S-glass fibres. The reinforcing fibres, in particular glass fibres, can be provided with sizing suitable for thermoplastics, in particular for polyamide, containing an adhesion promoter based on an amino- or epoxy silane compound.

According to a preferred embodiment, component B is a high-strength glass fibre or so-called S-glass fibre. This is preferably based on the ternary system silica-alumina-magnesia or on the quaternary system silica-alumina-magnesia-calcium oxide, wherein a composition of 58 to 70 wt% silica (SiO₂), 15 to 30 wt% alumina (Al₂O₃), 5 to 15 wt% magnesia (MgO), 0 to 10 wt% calcium oxide (CaO) and 0 to 2 wt% other oxides, such as zirconium dioxide (ZrO₂), boron oxide (B₂O₃), titanium dioxide (TiO₂), iron oxide (Fe₂O₃), sodium oxide, potassium oxide or lithium oxide (Li₂O) is preferred. In particular, it is preferred if the high-strength glass fibre has the following composition: 62 to 66 wt% silica (SiO₂), 22 to 27 wt% alumina (Al₂O₃), 8 to 12 wt% magnesia (MgO), 0 to 5 wt% calcium oxide (CaO), 0 to 1 wt% other oxides, such as the zirconium dioxide (ZrO₂), boron oxide (B₂O₃), titanium dioxide (TiO₂), iron oxide (Fe₂O₃), sodium oxide, potassium oxide and lithium oxide (Li₂O).

The polyamide moulding compounds according to the invention comprising cut fibres (short fibres) can be produced by the known compounding methods, wherein the polyamides and the additives are melted in an extruder and the cut fibres are preferably introduced into the polyamide melt and mixed with the polymer melt, before the fibre reinforced polymer moulding compound is discharged from the extruder and granulated. In this way, cylindrical granules with a length of 2 to 5 mm and a diameter of 2 to 4 mm are preferably produced.

The polyamide moulding compounds according to the invention comprising continuous fibres (long fibres) can be produced by the known methods for producing long-fibre reinforced rod-shaped granules, in particular by pultrusion, in which the continuous fibre strand (roving) is completely saturated with the polymer melt and then cooled and cut. As a rule, the polymer components and the additives are melted in an extruder and conveyed as a melt directly into the impregnation unit.

The long-fibre-reinforced rod-shaped granules obtained in this way, which preferably have a granule length from 3 to 25 mm, in particular from 4 to 12 mm, can be further processed into moulded parts using the usual processing methods (such as injection moulding, pressing), wherein particularly good properties of the moulded part can be achieved by application of gentle processing methods. In this context, gentle means above all that excessive fibre breakage and the associated strong reduction in fibre length are largely avoided. In the case of injection moulding, this means that large diameter screws should preferably be used.

The glass fibres used as continuous fibres (roving) in the pultrusion method can be provided with a suitable sizing system made of adhesion promoters and film formers. For example, organically functionalised silanes such as aminosilanes, epoxysilanes, vinylsilanes, methacrylsilanes or methacryloxysilanes can be used as adhesion promoters. For example, systems based on polyurethanes, polyesterurethanes, polyetherurethanes, polyhydroxyethers, epoxy resins, polyamides, acrylic polymers or mixtures thereof are preferably used as film formers.

From a material point of view, with regard to the composition of the polymer mixture A forming the polyamide matrix, the invention basically encompasses all combinations of the aliphatic polyamides mentioned under feature A1 with the semi-aromatic polyamides mentioned under feature A2. In this case, the aliphatic, semi-crystalline polyamides A1 are preferably selected from the group PA 6, PA 56, PA 66, PA 66/6, PA 610 and mixtures thereof. The polyamides A1 preferably have a solution viscosity ηᵣₑₗ, measured according to ISO 307:2007 in m-cresol (0.5 g polymer granules dissolved in 100 ml m-cresol, 20° C.) in the range from 1.3 to 2.7, preferably in the range from 1.4 to 2.3, in particular in the range from 1.50 to 2.00.

As is known from the prior art, the production of these aliphatic polyamides results through polymerisation or polycondensation of the corresponding lactams and/or aminocarboxylic acids and/or diamines and dicarboxylic acids, optionally using chain rules, preferably monocarboxylic acids or monoamines.

For the semi-aromatic polyamides A2, the copolyamides PA 6l/6T and PA 6T/BACT/66/BAC6 are particularly preferred. With regard to the copolyamides PA 6l/6T, composition ranges are particularly preferably which have a proportion of 6T units less than 50 mol%, wherein a composition range 6T:6l from 15:85 to 45:55 is particularly preferred. An amorphous, semi-aromatic polyamide 6l/6T (A2) with 55 to 85 mol% hexamethylene isophthalamide units and 15 to 45 mol% hexamethylene terephthalamide units is therefore preferred.

With regards to the copolyamides PA 6T/BACT/66/BAC6, composition ranges are particularly preferred which have a proportion of 6T and BACT units which together make up more than 60 mol%, particularly preferably less than 70 mol%, wherein a composition range 6T:BACT:66:BAC6 of 54-72:16-36:6-16:2-4 mol% is very particularly preferred. Preferred, in particular, is a semi-aromatic, semi-crystalline polyamide 6T/BACT/66/BAC6(A2) with 55 to 70 mol% hexamethylene terephthalamide units, 20 to 25 mol% 1,3-bis(aminomethyl)cyclohexane terephthalamide units, 6 to 16 mol% hexamethylene adipamide units and 2 to 4 mol% 1,3-bis(aminomethyl)cyclohexane adipamide units.

With regard to the polymer mixture (A), the following compositions are particularly preferred:
(A1): PA 66 or PA 610 or mixture of PA 66 and PA 6 or mixture of PA 610 and PA 6
(A2): PA 6l/6T, wherein the molar ratio is in the range from 65:35 to 75:25 or is in particular 67:33, and:
(A1): PA 66 or mixture of PA 66 and PA 6 or mixture of PA 610 and PA 6
(A2): PA 6T/BACT/66/BAC6, wherein the molar ratio of 6T and BACT units is greater than 60, preferably less than 70 mol%.

In a further preferred embodiment, the component A2 has a glass transition temperature of greater than 90° C., preferably greater than 110° C. and particularly preferably greater than 120° C.

In this case, the polyamides A2 preferably have a solution viscosity ηᵣₑₗ, measured according to ISO 307:2007 in m-cresol (0.5 g polymer granules dissolved in 100 ml m-cresol, 20° C.) in the range from 1.3 to 2.0, preferably in the range from 1.35 to 1.9, in particular in the range from 1.40 to 1.8.

As is known from the prior art, the production of the polyamides A2 takes place by reacting substantially molar amounts of the corresponding diamines and dicarboxylic acids, optionally using chain regulators, preferably monocarboxylic acids or monoamines.

The polyamide moulding compounds according to the invention also contain at least one metal borate compound in the range from 0.6 to 2.0 wt%, preferably 0.6 to 1.6 wt% and particularly preferably from 0.7 to 1.4 wt%, in each case with respect to the sum of the components A to D.

In this case the molar ratio of boron to metal (B:M ratio) in the metal borate compound is in the range from 0.5 to 4 and particularly preferably in the range from 1 to 3. The metal coexisting with boron in the metal borates is preferably an alkali, alkaline earth and transition metal, and may be present individually or in combination in the metal borates. Sodium, potassium, magnesium, calcium, barium and zinc are particularly preferred as metals. In addition, aluminium and silicon can also be present.

Suitable metal borate compositions are, for example, sodium borate, in particular borax pentahydrate (Na₂O·2B₂O₃·5H₂O), boraxdecahydrate (Na₂O·2B₂O₃·10H₂O), water-free Borax (Na₂O·2B₂O₃) and disodium octaborate tetrahydrate (Na₂O·4B₂O₃·4H₂O), magnesium borate (2MgO·B₂O₃), calcium borate (2CaO·3B₂O₃·5H₂O), calcium metaborate (CaO·B₂O₃·4H₂O), magnesium-calcium borate, e.g., hydroboracite (CaMg[B₃O₄(OH₃)₂]·3H₂O), barium metaborate (BaO·B₂O₃·H₂O), zinc borate (xZnO·yB₂O₃·zH₂O), such as 2ZnO.3B₂O₃.7H₂O, 2ZnO·3B₂O₃·3.5H₂O, 2ZnO·2B₂O₃·3H₂O, 4ZnO·B₂O₃·H₂O, 2ZnO·3B₂O₃, calcium silicate borate, sodium silicate borate, aluminium silicate borate, aluminium borate, copper borate and iron borate.

For the purposes of the invention, particularly preferred metal borate compounds are zinc borate with formula (ZnO)ₓ(B₂O₃)_{Y}(H2O)_{z}. In this case, it is further preferred if, in the given formula, X assumes values in the range from 2 to 4, Y assumes values in the range from 1 to 3, and Z assumes values in the range from 0 to 5.

Various zinc borate compounds are marketed, for example, by US Borax under the tradename Firebrake®. Particularly preferred forms of zinc borate are those in which X=4, Y=1 and Z=1 (Firebrake 415), in which X=2, Y=3 and Z=3.5 (Firebrake 290), in which X=2, Y=2 and Z=3 (Firebrake ZB-223) or in which X=2, Y=3 and Z=0 (Firebrake 500).

Particularly preferred are zinc borate compounds with a B:M ratio of 3 according to the formula (ZnO)₂(B₂O₃)₃(H2O)_{3.3-3.7}, wherein the water-free variant (ZnO)₂(B₂O₃)₃ is particularly preferred. In the context of the present invention, the metal borate, from the viewpoint of the mechanical strength and appearance of the moulded part, preferably has an average particle size of 30 µm or less, particularly preferably 20 µm or less. The mechanical strength can preferably be stabilised through the use of metal borate powders with a particle size of 1 to 20 µm.

The polyamide moulding compound according to the invention can also contain additives D as a further component, in an amount up to 5.0 wt%, preferably in an amount from 0 to 3.0 wt% and particularly preferably in an amount from 0.05 to 2.0 wt%. The additives D are different from the components A, B and C. In particular, component D is also different from copper halides and metal phosphinates. This means that the polyamide moulding compounds according to the invention are free from copper halides, such as copper(l)iodide. Furthermore, the moulding compounds according to the invention contain no flame retardants, in particular no metal phosphinates. The moulding compound comprises neither copper halides nor metal phosphinates.

Suitable additives are, for example, inorganic stabilisers, organic stabilisers, lubricants, dies and marking substances, inorganic pigments, organic pigments, IR absorbers, antistatic agents, anti blocking agents, crystallisation inhibitors, condensation catalysts, chain regulators, defoamers, chain extending additives, graphite, carbon nanotubes, mould release agents, separating agents, optical brighteners, photochromic additives, plasticisers, metallic pigments, metal flakes, metal coated particles. The polyamide moulding compounds according to the invention can contain stabilisers and/or anti-ageing agents, e.g., antioxidants, anti-ozone agents, light stabilisers, UV stabilisers, UV absorbers or UV blockers, heat stabilisers and mixtures thereof.

In a preferred embodiment, in addition to the above named stabilisers, component D also contains the following compounds selected from the group consisting of zinc oxide, zinc sulphide, zinc stearate, zinc montanate, calcium montanate, calcium stearate, aluminium stearate and mixtures thereof. Furthermore, it is preferred if these compounds are present in the moulding compound at 0.05 to 0.5 wt%, with respect to the components A to D.

Experiments have also shown that, in particular, a polyamide moulding compound which consists of the following components, has superior properties:
A: 46.6-69.25 wt% of a polymer mixture, consisting of
   A1 65 to 80 wt% polyamide PA6, PA 66 or PA 610 and mixtures thereof;
   A2 20 to 35 wt% polyamide PA 6l/6T, PA 6T/BACT/66/BAC6 and mixtures thereof;
   wherein the sum of A1 and A2 is 100 wt% of A;
B: 30-50 wt% long glass fibres (continuous glass fibres, rovings);
C: 0.7-1.4 wt% zinc borate with a B:M ratio of 0.5 to 4;
D: 0.05-2.0 wt% additive, different from A, B and C;
wherein the sum A to D is 100 wt% and wherein the moulding compound comprises neither copper halides nor metal phosphinates.

Surprisingly, it has been found that if the filled polyamide moulding compounds according to the invention are processed into moulded bodies, moulded bodies are obtained which have above-average properties, in particular in relation to notched impact strength, tensile strength at break, elongation at break, the heat distortion temperature and resistance to moulds and/or bacteria. In addition, it was surprisingly found that the addition of metal borates in combination with the preferably used long glass fibres (continuous glass fibres) has practically no negative effects on the mechanical properties of the moulding compound or of the moulded body. On the other hand, when so-called cut or short glass fibres are used, disadvantages in terms of the mechanical properties, in particular the notched impact strength, tensile strength at break and elongation at break must be tolerated.

It is clear that the long glass fibres (continuous fibres, rovings) that are preferably used according to the invention form a web or skeleton (fibre agglomerate) in the moulded body by wooling of the fibre fragments formed during the production of the moulded body, which effectively prevents crack propagation and thus contributes to shape retention at higher temperatures as well as to the notched impact strength and thus enables the excellent properties despite the presence of a pigment-like additive such as the metal borate.

The pronounced wooling of the long glass fibres in the moulded body is reinforced by the fact that the long glass fibres are less severely damaged during injection moulding. The preferably low-viscosity polyamide matrix in particular contributes to this. Therefore, even under unfavourable conditions, such as high shear during injection moulding in the production of a moulded part, it is ensured that the fibre fragments in the moulded body have a sufficient average length and length distribution that leads to a pronounced three-dimensional fibre agglomeration and thus to outstanding properties.

In the case of the moulding compounds reinforced with long glass fibres (continuous fibres, rovings) and the moulded bodies produced therefrom, it is particularly noteworthy that the notched impact strength at 23° C. remains substantially unchanged and constant due to the addition of metal borate, i.e., practically identical to the metal-borate-free moulding compound. On the other hand, when short glass fibres are used, the notched impact strength at 23° C. is reduced by up to 40% with respect to the metal-borate-free moulding compound, through the addition of metal borate. A similar behaviour can be observed with regard to the elongation at break. Here too, the preferably used long glass fibres show clear advantages.

Uncoated fillers, such as finely ground metal borates act as nucleating agents for semi-crystalline polyamides, i.e., they increase the crystallisation temperature and accelerate crystallisation. This is often accompanied by undesired embrittlement of fibre reinforced thermoplastics. Through suitable selection of the matrix components, such as the combination of a semi-crystalline, aliphatic polyamide A1 with an amorphous, semi-aromatic polyamide A2, the nucleating effect of the metal borate can be compensated.

The polyamide moulding compounds according to the invention have a heat distortion temperature HDT-C according to ISO 75:2013 of at least 120° C., preferably at least 130° C. and particularly preferably at least 200° C.

The polyamide moulding compounds according to the invention have a heat distortion temperature HDT-A according to ISO 75:2013 of at least 200° C., preferably at least 230° C.

The invention also relates to moulded bodies made from the described polyamide moulding compound or moulded bodies having at least one region or a coating made from a polyamide moulding compound, preferably produced by injection moulding, extrusion or blow moulding, which is preferably a moulded body in the following fields: housings, covers or frames, a housing or a housing component, preferably housings or housing parts for portable electronic devices, claddings or covers, domestic devices, domestic appliances, spectacle mountings, spectacle frames, sunglasses, cameras, spy glasses, decorative items, devices and apparatuses for telecommunications and consumer electronics, interior and exterior parts in the automotive sector and in the field of other transport means, interior and exterior parts, preferably with support or mechanical function in the field of electronics, furniture, sports, mechanical engineering, sanitation and hygiene, fans, in particular a fan rotor or a fan wheel, medicine, energy and drive technology, particularly preferably mobile phones, smartphones, organisers, laptop computers, notebook computers, tablet computers, radios, cameras, watches, calculators, sensor housings, measurement devices, players for music and/or video, navigation devices, GPS devices, electronic picture frames, external hard drives and other electronic storage media.

The moulded bodies preferably meet the requirements for fungicidal surfaces according to method A of DIN EN ISO 846:2020 and the test according to the method described in Annex C preferably gives the classification “ZERO” (0) or “ONE A” (1a). Additionally or alternatively, the moulded bodies meet the requirements for resistance to bacteria according to method C of DIN EN ISO 846: 2020 and the test according to the method described in annex C preferably gives the classification “ZERO” (0).

The invention also relates to the use of the described polyamide moulding compound for producing mould-resistant and bacteria-resistant moulded bodies, in particular for door handles, hands-free door openers, handrails, kitchen appliances, medical devices, automotive interior functional parts, steering wheels with levers and buttons, gearsticks, control units for air-conditioning systems, control units for entertainment devices, door locking systems, hinges, handles, grab handles and bars in public transport, medical care beds, hospital furniture, knobs and control elements in lifts, kitchen furniture, bathroom furniture and accessories, housings and covers, ventilation systems, fans, axial fans, centrifugal fans, process fan rotors.

The invention will be explained in greater detail by way of the following example. The following materials were used in the examples and comparative examples:

| | |
|---|---|
| PA-1: | polyamide-66 with ηᵣₑₗ = 1.82, Tm = 262° C., RADICI, IT |
| PA-2: | polyamide-6 with ηᵣₑₗ = 1.80, Tm = 222° C., BASF, DE |
| APA-1: | polyamide 6l/6T (67:33) with ηᵣₑₗ = 1.50, Tg = 125° C., EMS-CHEMIE AG, CH |
| APA-2: | polyamide 6T/BACT/66/BAC6 (68.5/23.5/6/2) with ηᵣₑₗ = 1.65, Tm = 325° C., Tg = 150° C., EMS-CHEMIE AG, CH |
| LGF-1: | E-glass roving NEG TufRov 4510-17-2400, round cross-sectional area with diameter 17 µm, sizing system with aminosilane-based adhesion promoter and epoxy resin-based film former. |
| LGF-2: | E-glass roving NEG TufRov 4510-12-1200, round cross-sectional area with diameter 12 µm, sizing system with aminosilane-based adhesion promoter and epoxy resin-based film former. |
| GF: | ECR-glass short fibre bundle, Vetrotex 995 EC10-4.5, length: 4.5 mm, filament diameter: 10 µm, Saint-Gobain Vetrotex, FR |
| Metal borate: | Firebrake 500, (ZnO)₂(B₂O₃)₃, M:B = 3, U.S. Borax, USA |
| Stabiliser: | mixture of Irganox 1098 (BASF, DE) and Brüggolen H10 (Brüggemann, DE) in the ratio 2:1 |
| Zinc sulphide: | Sachtolith HD-S, ZnS, Huntsman, USA |

The moulding compounds of the compositions B7 to B10, B12 and B13 in Table 2 were produced on a twin-screw extruder from Werner and Pfleiderer, model ZSK 30. The granules of components A1 and A2 and additives C and D were metered into the feed zone. The glass fibres (GF, short glass fibres) were metered into the polymer melt via a side feeder 3 housing units in front of the nozzle. The housing temperature was set as a rising profile from 270 to 300° C. A throughput of 10 kg was achieved at 150 to 200 rpm. The granulation was carried out by means of underwater granulation or hot cutting under water, in which the polymer melt is pressed through a perforated die and granulated by a rotating knife in a water stream immediately after exiting the die. After granulation and drying at 110° C. for 24 hours, the granule properties were measured and the test specimens produced.

The continuously reinforced compositions B1 to B6 (Table 1) and B11 (Table 2) were produced by a pultrusion method, in which the polymer mixtures A with additives C and/or D were mixed and melted in a twin-screw extruder, before being transferred into an impregnation unit and brought into contact with the preheated continuous filament glass fibres (LGF-1 and LGF-2, continuous glass fibres). More specifically, the pultrusion process proceeded as follows: The components A1, A2, C and D were metered into the feed zone of a twin-screw extruder with a screw diameter of 40 mm. The components were then mixed with a rising temperature profile from 270 to 340° C. The extruder, which is securely connected to the impregnation unit, conveys the melt directly into the impregnation unit, so that the glass fibres, which are preheated to 180 to 220° C., are infiltrated. The continuous glass fibres, 1200 tex rovings in the case of 12 µm fibres and 2400 tex rovings in the case of 17 µm fibres, are drawn at a speed of 8 to 15 metres per minute through the impregnating zone, with heating zones in the range from 340 to 400° C. After cooling in water, the thus-impregnated strands were cut to a length of 10 mm. After pelletisation and drying for 24 hours at 110° C., the properties of the pellets were measured and the test specimens produced.

The test specimens were produced on an Arburg injection moulding system, wherein cylinder temperatures of 260° C. to 300° C. and a peripheral screw speed of 15 m/min were set. A mould temperature of 100-140° C. was selected.

The measurements were carried out according to the following standards and on the following specimens.

### Tensile Modulus of Elasticity

The tensile modulus of elasticity was determined in accordance with ISO 527 (2012) at 23° C. with a draw speed of 1 mm/min on an ISO tensile rod (type A1, mass 170 × 20/10 × 4) according to the standard: ISO/CD 3167 (2003).

### Tensile Stress at Break and Elongation at Break

The tensile stress at break and elongation at break were determined in accordance with ISO 527 (2012) at 23° C. with a draw speed of 5 mm/min on an ISO tensile rod type A1 (mass 170 × 20/10 x 4 mm) according to the standard: ISO/CD 3167 (2003).

### Impact Strength According to Charpy

The Charpy impact strength was determined in accordance with ISO 179/2*eU (1997,* 2 = instrumented) at 23° C. on an ISO test rod, type B1 (dimensions 80 × 10 × 4 mm), produced in accordance with the ISO/CD 3167 (2003).

### Notch Impact Strength According to Charpy

The Charpy notch impact strength was determined in accordance with ISO 179/2*eA (1997,* 2 = instrumented) at 23° C. on an ISO test rod, type B1 (dimensions 80 × 10 × 4 mm), produced in accordance with the ISO/CD 3167 (2003).

### Melting Point (Tₘ) and melting enthalpy (ΔHₘ)

The melting point and melting enthalpy were determined on granules according to DIN EN ISO 11357-3: 2018. The DSC (differential scanning calorimetry) measurements were carried out with a heating rate of 20 K/min.

### Glass Transition Temperature, T_{g}

The glass transition temperature T_{g} was determined in accordance with DIN EN ISO 11357-2:2020 on granules by means of differential scanning calorimetry (DSC). This was carried out for each of the two heatings at a heating rate of 20 K/min. After the first heating, the sample was quenched in dry ice. The glass transition temperature (T_{g}) was determined during the second heating. The midpoint of the glass transition area, which was given as the glass transition temperature, was determined by the “Half Height” method.

### Relative Viscosity, Ηᵣₑₗ

The relative viscosity was determined according to ISO 307 (2007) at 20° C. For this purpose, 0.5 g of polymer granules were weighed into 100 ml of m-cresol, and the calculation of the relative viscosity (ηᵣₑₗ) according to ηᵣₑₗ = t/t₀ was with respect to Section 11 of the standard.

### Heat Deflection Temperature (HDT)

The heat deflection temperature or also called the deformation temperature under load (HDT) is reported as HDT/A and/or HDT/C. HDT/A corresponds to method A with a flexural stress of 1.80 MPa and HDT/C corresponds to method C with a flexural stress of 8.00 MPa. The HDT values were determined in accordance with ISO 75 (2013) on ISO impact bars measuring 80 × 10 × 4 mm.

### Determination of the Actions of Microorganisms on Plastics

The resistance to moulds and bacteria was determined according to methods A and C of DIN EN ISO 846:2020 using plates with dimensions 50 × 50 × 2 mm. The evaluation was carried out using the method described in Annex C.

Unless otherwise noted in the tables, the test specimens were used to determine the mechanical properties in the dry state. For this purpose, the test specimens were stored in a dry environment at room temperature for at least 48 hours after injection moulding.

TABLE 1

Composition and properties of the examples B1 to B6

| Example | Units | B1 | B2 | B3 | B4 | B5 | B6 |
|---|---|---|---|---|---|---|---|
| Composition | | | | | | | |
| PA-1 (component A1) | wt% | 44.1 | 43.8 | 36.75 | 36.75 | 44.1 | 36.75 |
| APA-1 (component A2) | wt% | 14.7 | 14.6 | 12.25 | 12.25 | | |
| APA-2 (component A2) | wt% | | | | | 14.7 | 12.25 |
| LGF-1 (component B) | wt% | 40.0 | 40.0 | 50.0 | | 40.0 | |
| LGF-2 (component B) | wt% | | | | 50.0 | | 50.0 |
| GF (component B) | wt% | | | | | | |
| Metal borates (component C) | wt% | 0.90 | 1.30 | 0.75 | 0.75 | 0.90 | 0.75 |
| Stabiliser (component D) | wt% | 0.30 | 0.30 | 0.25 | 0.25 | 0.30 | 0.25 |
| Properties | | | | | | | |
| HDT A | °C | 255 | 254 | 255 | 255 | 253 | 258 |
| HDT C | °C | 208 | 208 | 217 | 218 | 210 | 220 |
| Tensile modulus of elasticity | MPa | 14100 | 14100 | 17400 | 17600 | 14500 | 17800 |
| Tensile stress at break | MPa | 238 | 235 | 268 | 288 | 242 | 290 |
| Elongation at break | wt.% | 2.5 | 2.4 | 2.5 | 2.6 | 2.5 | 2.4 |
| Impact strength Charpy, 23° C. | kJ/m² | 84 | 82 | 100 | 110 | 105 | 110 |
| Notch impact strength Charpy, 23° C. | kJ/m² | 30 | 29 | 33 | 38 | 45 | 42 |
| Resistance to moulds (ISO 846, method A) | | 1a | 0 | 1a | 1a | 1a | 1a |
| Resistance to bacteria (ISO 846, method C) | | 0 | 0 | 0 | 0 | 0 | 0 |

The moulding compounds according to the invention of examples B1-B8 show good to very good resistance to moulds and bacteria and therefore clear advantages compared to the comparative examples B9 to B13. Example B11 shows that the selected metal borate concentration is too low to achieve a sufficient resistance to mould. A comparison of examples B9 and B10 with examples B1 to B4 shows that the preferably used continuous glass fibres have advantages with respect to the heat distortion temperature HDT-C, tensile strength at break, elongation at break and notched impact strength. On the other hand, the resistance to mould and bacteria is at the same high level as examples B1, B2 and B4.

TABLE 2

Composition and properties of examples B7 and B8 and of comparative examples B9 to B13

| Example | Units | B7 | B8 | B9 | B10 | B11 | B12 | B13 |
|---|---|---|---|---|---|---|---|---|
| Composition | | | | | | | | |
| PA-1 (component A1) | wt% | 44.1 | 36.75 | 44.8 | 37.3 | 44.4 | 44.8 | |
| PA-2 (component A1) | wt% | | | | | | | 68.5 |
| APA-1 (component A2) | wt% | 14.7 | 12.25 | 14.9 | 12.4 | 14.8 | 14.9 | |
| LGF-1 (component B) | wt% | | | | | 40.0 | | |
| LGF-2 (component B) | wt% | | | | | | | |
| GF (component B) | wt% | 40.0 | 50.0 | 40.0 | 50.0 | | 40.0 | 30.0 |
| Metal borates (component C) | wt% | 0.90 | 0.75 | | | 0.50 | | 1.00 |
| Stabiliser (component D) | wt% | 0.30 | 0.25 | 0.30 | 0.25 | 0.30 | 0.25 | 0.50 |
| Zinc sulphide (component D) | wt% | | | | | | 0.05 | |
| Properties | | | | | | | | |
| HDT A | °C | 235 | 235 | 235 | 235 | 255 | 237 | 205 |
| HDT C | °C | 142 | 160 | 145 | 165 | 210 | 148 | 135 |
| Tensile modulus of elasticity | MPa | 14000 | 18200 | 14000 | 18000 | 14000 | 14100 | 9500 |
| Tensile stress at break | MPa | 205 | 211 | 230 | 250 | 240 | 232 | 185 |
| Elongation at break | wt.% | 2.1 | 1.9 | 3.0 | 2.5 | 2.5 | 3.0 | 4.2 |
| Impact strength Charpy, 23° C. | kJ/m² | 70 | 74 | 90 | 90 | 85 | 88 | 85 |
| Notch impact strength Charpy, 23° C. | kJ/m² | 8 | 10 | 14 | 17 | 30 | 13 | 12 |
| Resistance to moulds (ISO 846, method A) | | 1a | 1a | 4 | 4 | 2 | 3 | 3 |
| Resistance to bacteria (ISO 846, method C) | | 0 | 0 | 0 | 0 | 0 | 1 | 1 |

In order to assess mould growth, a grid with 100 equal-size squares was placed on the incubator sample plates with dimensions 50 × 50 × 2 mm, and the squares which showed growth were counted, the 36 squares at the edge not being included in the evaluation. Based on the number of squares with mould growth that are visible to the naked eye or a microscope, the following score was determined:
0: None of the inner squares show mould growth that can be detected under the microscope at 50x magnification
1a: 1 to 16 squares show traces of mould growth under the microscope at 50x magnification
2: 1 to 16 squares have mould growth when observed with the naked eye
3: 17 to 32 squares have mould growth when observed with the naked eye
4: 33 to 64 squares have mould growth when observed with the naked eye

The assessment of the incubated sample plates with regard to resistance to bacteria was carried out analogously to the mould test, wherein squares with bacterial growth visible to the naked eye were counted:
0: The inner squares are free of bacterial growth
1: 1 to 16 squares show traces of bacterial growth

1. A polyamide moulding compound consisting of
A 33-79.4 wt% of a polymer mixture consisting of
A1 55 to 85 wt% of at least one semi-crystalline, aliphatic polyamide selected from the group PA 6, PA 46, PA 56, PA 66, PA 66/6, PA 610, PA 612, PA 6/12, PA 1010, PA 11, PA 12, PA 1012, PA 1212 and mixtures thereof;
A2 15 to 45 wt% of at least one semi-aromatic polyamide selected from the group PA 6I, PA 5I/5T, PA 6I/6T, PA 10I/10T, PA 10T/6T, PA 6T/BACT/66/BAC6, PA MXD6, PA MXD6/MXDI and mixtures thereof;
wherein the sum of A1 and A2 is 100 wt% of A;
B 20 to 60 wt% of a reinforcing fibre;
C 0.6 to 2.0 wt% metal borate, wherein the molar ratio of metal to boron is in the range from 0.5 to 4;
D 0 to 5.0 wt% additives, different from A, B and C;
wherein the sum of the components A to D is 100 wt% and wherein the moulding compound comprises neither copper halides nor metal phosphinates.

2. The polyamide moulding compound according to claim 1, characterised in that
the proportion of component A is in the range from 40.4 to 74.4 wt%, preferably in the range from 46.6 to 69.25 wt%, in each case with respect to sum of components A to D; and/or
the proportion of component A1 is in the range from 60 to 85 wt%, preferably in the range from 65 to 80 wt%, and the proportion of component A2 is in the range from 15 to 40 wt%, preferably in the range from 20 to 35 wt%, in each case with respect to the sum of components A1 and A2; and/or
the proportion of component B is in the range from 25 to 55 wt%, preferably in the range from 30 to 50 wt%, in each case with respect to the sum of components A to D; and/or
the proportion of component C is in the range from 0.6 to 1.6 wt%, preferably in the range from 0.7 to 1.4 wt%, in each case with respect to the sum of components A to D; and/or
the proportion of component D is in the range from 0 to 3.0 wt%, preferably in the range from 0.05 to 2.0 wt%.

3. The polyamide moulding compound according to claim 1, characterised in that
the polyamide A1 is selected from PA6, PA 56, PA 66, PA 66/6, PA 610 and mixtures thereof; and/or
the polyamide A2 is selected from PA 6I/6T, PA 6T/BACT/66/BAC6 and a mixture thereof.

4. The polyamide moulding compound according to claim 1, characterised in that the component A2 is selected from
an amorphous, semi-aromatic polyamide PA 6I/6T with 55 to 85 mol% hexamethylene isophthalamide units and 15 to 45 mol% hexamethylene terephthalamide units and/or
a semi-crystalline, semi-aromatic polyamide PA 6T/BACT/66/BAC6 with 55 to 70 mol% hexamethylene terephthalamide units, 20 to 25 mol% 1,3-bis(aminomethyl)-cyclohexane terephthalamide units, 6 to 16 mol% hexamethylene adipamide units and 2 to 4 mol% 1,3-bis(aminomethyl)cyclohexane adipamide units.

5. The polyamide moulding compound according to claim 1, characterised in that the reinforcing fibre B is
a glass fibre; and/or
is selected from the group consisting of E-glass fibres, ECR-glass fibres, D-glass fibres, L-glass fibres, S-glass fibres and/or R-glass fibres; and/or
a long glass fibre (continuous glass fibre, roving); and/or
has a diameter in the range from 10 to 20 µm, preferably in the range from 12 to 17 µm.

6. The polyamide moulding compound according to claim 1, characterised in that
the heat distortion temperature HDT-C according to ISO 75:2013 is at least 120° C., preferably at least 130° C., in particularly preferably at least 200° C.; and/or
the heat distortion temperature HDT-A according to ISO 75:2013 is at least 200° C., preferably at least 230° C.

7. The polyamide moulding compound according to claim 1, characterised in that the metal borate C is selected from the group consisting of: sodium borate, in particular borax pentahydrate Na2O·2B2O3·5H2O, borax decahydrate Na2O·2B2O3·10H2O, water-free borax Na2O·2B2O3 and disodium octaborate tetrahydrate Na2O·4B2O3·4H2O, magnesium borate 2MgO·B2O3, calcium borate 2CaO·3B2O3·5H2O, calcium metaborate CaO·B2O3·4H2O, magnesium calcium borate, e.g., hydroboracite CaMg[B3O4(OH)3]2·3H2O, barium metaborate (BaO·B2O3·H2O), zinc borate xZnO·yB2O3·zH2O, for example 2ZnO·3B2O3·7H2O, 2ZnO·3B2O3·3.5H2O, 2ZnO·2B2O3·3H2O, 4ZnO·B2O3·H2O, 2ZnO·3B2O3, calcium silicate borate, sodium silicate borate, aluminium silicate borate, aluminium borate, copper borate, iron borate.

8. The polyamide moulding compound according to claim 1, characterised in that the metal borate C selected is a zinc borate compound with a boron:metal ratio of 1 to 3, preferably 3.

9. The polyamide moulding compound according to claim 1, characterised in that the component D is selected from the following group: UV stabilisers, heat stabilisers, which are free of copper halides, radical scavengers, processing aids, inclusion inhibitors, lubricants, mould release aids, crystallisation accelerators or retardants, flow promoters, lubricants, mould release agents, pigments, dyes and marking substances, optical brighteners, processing agents, antistatic agents, carbon black, graphite, carbon nanotubes.

10. The polyamide moulding compound according to claim 1, characterised in that component D is selected from UV stabilisers, heat stabilisers, zinc oxide, zinc sulphide, zinc stearate, zinc montanate, calcium montanate, calcium stearate, aluminium stearate and mixtures thereof.

11. The polyamide moulding compound according to claim 1, characterised in that the moulding compound consists of the following components:
A: 46.6-69.25 wt% of a polymer mixture, consisting of
A1 65 to 80 wt% polyamide PA6, PA 66, PA 610 and mixtures thereof;
A2 20 to 35 wt% polyamide PA 6I/6T, PA 6T/BACT/66/BAC6 and mixtures thereof;
wherein the sum of A1 and A2 is 100 wt% of A;
B: 30-50 wt% long glass fibres (continuous glass fibres, rovings);
C: 0.7-1.4 wt% zinc borate with a boron:metal ratio of 0.5 to 4;
D: 0.05-2.0 wt% additive, different from A, B and C;
wherein the sum A to D is 100 wt% and wherein the moulding compound comprises neither copper halides nor metal phosphinates.

12. A moulded body made from a polyamide moulding compound according to claim 1 or having at least one region or a coating made from a polyamide moulding compound according to one of the preceding claims, preferably produced by injection moulding, extrusion or blow moulding, wherein it is preferably a moulded body in the field of housings, covers or frames, a housing or a housing component, preferably housings or housing parts for portable electronic devices, claddings or covers, domestic devices, domestic appliances, spectacle mounting, spectacle frames, sunglasses, cameras, spy glasses, decorative items, devices and apparatuses for telecommunications and consumer electronics, interior and exterior parts in the automotive sector and in the field of other transport means, interior and exterior parts, preferably with support or mechanical function in the field of electronics, furniture, sports, mechanical engineering, sanitation and hygiene, fans, in particular a fan rotor or fan wheel, medicine, energy and drive technology, particularly preferably mobile phones, smartphones, organisers, laptop computers, notebook computers, tablet computers, radios, cameras, watches, calculators, sensor housings, measurement devices, players for music and/or video, navigation devices, GPS devices, electronic picture frames, external hard drives and other electronic storage media.

13. The moulded body according to claim 12, characterized in that
the requirements for fungicidal surfaces according to method A of DIN EN ISO 846:2020 are met and the test according to the method described in Annex C gives the classification “ZERO” or “ONE A” or “ONE”; and/or
the resistance to bacteria according to method C of DIN EN ISO 846: 2020 is met and the test according to the method described in Annex C gives the classification “ZERO” or “ONE”.

14. A use of a polyamide moulding compound according to claim 1 for producing mould-resistant and bacteria-resistant moulded bodies, in particular for door handles, hands-free door openers, handrails, kitchen appliances, medical devices, automotive interior functional parts, steering wheels with levers and buttons, gearsticks, control units for air-conditioning systems, control units for entertainment devices, door locking systems, hinges, handles, grab handles and bars in public transport, medical care beds, hospital furniture, knobs and control elements in lifts, kitchen furniture, bathroom furniture and accessories, housings and covers, ventilation systems, fans, axial fans, centrifugal fans, process fan rotors.
